(19) United States
(12) Patent Application Publication
(10) Pub. No.: US 2019/0366407 A1
(43) Pub. Date: Dec. 5, 2019

(54) METHOD OF PRODUCING A MOTOR VEHICLE COMPONENT FROM A HIGH-STRENGTH STEEL ALLOY HAVING DUCTILE PROPERTIES AND MOTOR VEHICLE COMPONENT

(71) Applicant: BENTELER AUTOMOBILTECHNIK GMBH, Paderborn (DE)

(72) Inventors: Martin HOLZWEISSIG, Paderborn (DE); Markus KETTLER, Schlangen (DE); Karsten BAKE, Delbrueck (DE); Georg FROST, Steinheim (DE); Andreas FREHN, Delbrueck (DE)

(21) Appl. No.: 16/425,386

(22) Filed: May 29, 2019

(30) Foreign Application Priority Data
May 30, 2018 (DE) 10 2018 112 934.3

(51) Int. Cl. B21D 22/20; B21D 53/88; B62D 25/04; C21D 1/76; C21D 3/04; C21D 1/18; C22C 38/00

(52) U.S. Cl. CPC B21D 22/208; B21D 53/88; B62D 25/04; C22C 38/00; C21D 3/04; C21D 1/18; C21D 1/76

(57) ABSTRACT

The present invention relates to a method of producing a motor vehicle component and to a motor vehicle component. Said motor vehicle component is produced by means of hot forming and press hardening. A blank is heated in a continuous furnace with supply of nitrogen. This produces a skin-decarburized layer on the blank that achieves ductility in a motor vehicle component produced with ultrahigh strength.

### RELATED APPLICATIONS

The present application claims priority to German Application Number 10 2018 112 934.3 filed May 30, 2018, which is incorporated by reference herein its entirety.

### FIELD

The disclosure relates to a method of producing a motor vehicle component produced by hot forming and press hardening.

The disclosure further relates to a motor vehicle component produced by hot forming and press hardening.

The prior art discloses producing motor vehicle components from a hardenable steel alloy. For this purpose, hot forming and press hardening are used. This involves heating a blank of a hardenable steel alloy to a temperature not less than the AC3 temperature. The AC3 temperature is also referred to as the austenitization temperature and, according to the steel alloy used, is more than 800° C.

If the blank has been fully austenitized, it has high degrees of forming. The motor vehicle component is thus produced from the blank by forming in a forming operation.

During and after the forming, the blank or formed component is cooled sufficiently rapidly that the austenitized material is converted to a hardened material microstructure. This is a martensitic material microstructure. It is also possible for fractions of ferrite, pearlite or bainite to be present in the hardened material microstructure. The above-described process is also called press hardening.

In the last few years, the prior art has disclosed producing motor vehicle components having a tensile strength RM greater than 1000 MPa, especially greater than 1200 and preferably also greater than 1500 MPa.

If components having even higher tensile strengths are then produced, especially exceeding 1700 and preferably exceeding 1800 MPa, these components have only low ductility. This results in bending angles of about 30° in the component. In the case of an accident, there can be brittleness fractures and/or breakoff of further components secured to this component by welding for example.

### SUMMARY

It is therefore an object of at least one embodiment of the disclosure to produce a component with ultrahigh-strength material properties with high ductility, wherein the process costs for production of the component are low and it is especially possible to make use of existing plant technology.

The method according to at least one embodiment of the disclosure for producing a motor vehicle component envisages using a hot forming and press hardening process. For this purpose, a blank made of a hardenable carbon-containing steel alloy is heated at least in regions, especially completely, to above AC3 temperature. The carbon content is greater than 0.3% by mass. However, the carbon content is not more than 1% by mass. The blank to be heated is heated in a continuous furnace. The heated blank is removed from the continuous furnace and transferred into a hot forming and press hardening mold. In the hot forming and press hardening mold, a hot forming operation and a press hardening process are conducted.

An ultrahigh-strength steel alloy is used here, with which it is possible to provide a motor vehicle component having a tensile strength Rm of at least 1700 MPa preferably more than 1800 MPa on completion of the press hardening process.

In order that this motor vehicle component, also called component, having ultrahigh-strength properties as it were has a high measure of ductility, especially a bending angle greater than 50°, preferably greater than 60°, skin decarburization is conducted during the heating in the continuous furnace. The bending angle is especially determined in the plate bending test to VDA238-100.

What is envisaged is that a furnace atmosphere within the continuous furnace is established by the supply of ambient air and of nitrogen of technical grade purity. In the continuous furnace, the oxygen content in percent by volume is measured in the furnace atmosphere. According to at least one embodiment of the disclosure, an oxygen content of 0.5-15% by volume, preferably between 0.5% and 10% by volume, especially between 0.5% and 5% by volume and more preferably between 0.5% and 3% by volume is established in the furnace atmosphere. The oxygen content is established via the closed-loop control of the nitrogen volume flow rate into the continuous furnace.

It has been found in accordance with at least one embodiment of the disclosure that it is thus possible to conduct skin decarburization on the blank to be heated, in such a way that the carbon atoms in a respective skin layer of the blank to be heated are bonded to the oxygen. By virtue of the respectively skin-decarburized layer, the component produced later by hot forming and press hardening has a higher ductility. Scaling of the surface is likewise very substantially avoided.

The supply of ambient air can be effected by feeding the air in from the outside into the interior of the furnace. However, the air or the oxygen in the interior of the furnace preferably comes from the immediate environment of the continuous furnace.

It has been found here, advantageously in accordance with at least one embodiment of the disclosure, that, when a skin-decarburized layer having a layer thickness of 10-70 μm above or between 10 and 50 μm and preferably of 20 to 40 μm is established on either side of the component, such that a motor vehicle component having a tensile strength Rm greater than 1700 MPa preferably greater than 1800 MPa and a bending angle greater than 50°, especially greater than 60°, can be produced.

It is also possible to conduct the method in accordance with at least one embodiment of the disclosure in existing production plants by, in an existing production plant, retrofitting a nitrogen supply and a closed-loop control method for adjustment of the oxygen content in the furnace atmosphere.

A continuous furnace is typically operated with gas burners in steel pipes. The combustion process itself takes place separately from the establishment of the oxygen content of the furnace atmosphere. Alternatively, steel pipes can be executed in resistance-heated form.

In addition, more preferably, the nitrogen volume flow rate which is guided into the continuous furnace may have a value per hour, for example in m³. This value is preferably between two times and four times, preferably between 2.5 times and 3.5 times, the volume, and this value preferably corresponds to three times the volume of the continuous furnace.

It has also been found to be advantageous when the nitrogen, based on the spatial direction, is introduced into the continuous furnace above the blanks to be heated. This generates convection characteristics of the nitrogen within the continuous furnace, such that no further mixing of the internal furnace atmosphere is required.

The method in accordance with at least one embodiment of the disclosure can preferably be used to process tailored blanks. More particularly, the tailored blanks are rolled blanks. However, it is also possible to process tailored formed blanks or tailored welded blanks. As it were, it is of course also possible to process blanks with constant wall thickness.

In addition, it is likewise possible by the method in accordance with at least one embodiment of the disclosure to undertake additional coating on the component produced. This may especially be a subsequently applied anticorrosion coating, for example cathodic electrocoating or zinc diffusion coating.

It has also been found to be advantageous when the blank runs through the continuous furnace within a period of 120 sec to 10 min, especially 120 sec to 400 sec, more preferably of 160 to 200 sec and especially about 180 sec.

It is also envisaged that a temperature between 910 and 980° C., especially of 930-960° C., prevails in the continuous furnace itself.

Alternatively or additionally, the temperature in the continuous furnace may be at least 5%, preferably 10%, especially 11%, preferably 12%, above the AC3 temperature of the steel alloy used. However, the internal furnace temperature does not exceed the AC3 temperature of the steel material used by 30%, especially preferably not by 20%.

In the context, it has been found to be particularly advantageous when a steel alloy is used that comprises, as well as iron and melting-related impurities, the following alloy elements, expressed percent by mass:

| C (carbon) | 0.3-0.4 | | preferably | 0.32-0.38 | |
|---|---|---|---|---|---|
| Si (silicon) | 0.15-1 | | preferably | 0.2-0.5 | |
| Mn (manganese) | 0.5-2 | | preferably | 0.8-1.5 | |
| P (phosphorus) | max. | 0.05 | preferably | max. | 0.02 |
| S (sulfur) | max. | 0.01 | preferably | max. | 0.005 |
| N (nitrogen) | max. | 0.01 | preferably | max. | 0.005 |
| Cr (chromium) | 0.05-1 | | preferably | 0.1-0.5 | |
| Ni (nickel) | max. | 0.3 | preferably | max. | 0.1 |
| Cu (copper) | max. | 0.1 | preferably | max. | 0.05 |
| Mo (molybdenum) | max. | 0.5 | preferably | max. | 0.3 |
| Al (aluminum) | max. | 0.1 | preferably | max. | 0.06 |
| Nb (niobium) | 0.02-0.1 | | preferably | 0.02-0.06 | |
| V (vanadium) | max. | 0.06 | preferably | max. | 0.05 |
| Ti (titanium) | max. | 0.1 | preferably | max. | 0.01 |

| | | | |
|---|---|---|---|
| B (boron) | 0.001-0.01 | preferably | 0.001-0.005 |

The carbon content brings about the strength/hardness in the component produced. Silicon brings retardation of conversion and promotes tempering resistance. Manganese likewise brings retardation of conversion by stabilization of the austenite. Chromium likewise brings retardation of conversion and scaling resistance. Boron also brings about retardation of conversion. Niobium results in a fine-grain structure in the material microstructure.

In the context, the method can thus preferably be conducted with a steel alloy specified in the table. However, the method can also be conducted with other carbon-containing steel alloys, especially those having a carbon content greater than 0.3 percent by mass. The motor vehicle component described below may likewise have been produced from the aforementioned steel alloy. However, the carbon content does not exceed 1% by mass.

At least one embodiment of the disclosure further relates to a motor vehicle component produced by hot forming and press hardening from a blank. The blank itself has been produced from a hardenable steel alloy. More particularly, the motor vehicle component has been produced by an above-described method in accordance with at least one embodiment of the disclosure. The motor vehicle component can be a bumper beam, a cross beam or a door impact beam. The motor vehicle component can also be a longitudinal beam or a cross beam in a crash body structure of a vehicle. Also the motor vehicle component can be a beam in a battery tray carrier for an electric powered vehicle.

According to at least one embodiment of the disclosure, it is a feature of the motor vehicle component that it has a tensile strength Rm greater than 1800 MPa, especially greater than 1900 MPa preferably greater than 2000 MPa. The tensile strength especially does not exceed 2500 MPa.

The motor vehicle component can also have partial soft zones. In these soft zones the strength especially the tensile strength is lower than the values above. Especially the tensile strength Rm in the soft zones is between 550 and 1100 MPa preferably between 600 and 1000 MPa and more preferably between 650 and 900 MPa. Especially the soft zones are produced for example with a heat treatment operation. The soft zones are preferably in joining flanges and/or trim edges of the motor vehicle part. So the motor vehicle part can be easily trimmed in a cutting operation and/or joined with other components via the flanges in a joining operation.

Also there can be other strength values if the motor vehicle component is treated with a cathodic dip painting (kathodische Tauchlackierung=KTL). Especially the cathodic dip painting can be performed in the above mentioned method. Preferably the tensile strength Rm is greater 1700 MPa especially greater 1750 MPa and more preferably greater than 1800 MPa after the part has been treated with the cathodic dip painting.

The yield strength Rp0,2 of the motor vehicle component before the cathodic dip painting is preferably greater 1150 MPa, especially greater than 1250 MPa and more preferably greater than 1300 MPa.

The yield strength Rp0,2 of the motor vehicle component after the cathodic dip painting has been performed is preferably greater 1300 MPa especially greater 1400 MPa and more preferably greater 1500 MPa.

The elongation at break (Bruchdehnung A50) is greater than 4% especially greater than 6% and more preferably greater than 7% before and after performing the cathodic dip painting.

The motor vehicle component also has high ductility. It is a feature of ductility that a bending angle greater than 50°, especially greater than 60°, is present in the motor vehicle component. Typically, the motor vehicle component has a thickness between 0.7 mm and 3.5 mm. A skin-decarburized layer has preferably been formed on each surface of the motor vehicle component, where the skin-decarburized layer has a layer thickness of 10 to 70 μm, preferably of 20 to 40 μm.

It is a feature of a layer boundary from skin-decarburized to non-skin-decarburized layer that, in the skin-decarburized layer, the carbon content corresponds to max. 50% in relation to a core layer, i.e. a middle layer, of the motor vehicle component produced. This means that, coming from the surface, the edge-decarburized layer ends at the point where the carbon content in the direction toward the interior of the motor vehicle component exceeds 50% of the carbon content at a middle position in the motor vehicle component. These figures are likewise applicable to the production method described above.

### BRIEF DESCRIPTION OF THE DRAWINGS

The disclosure is further described by the elucidations which follow and illustrated by the schematic figures that are to serve for easy understanding.

FIG. 1 is a schematic method progression for production of a motor vehicle component,

FIG. 2 is a motor vehicle component produced in accordance with at least one embodiment of the disclosure in the form of an B pillar and

FIG. 3 is a cross-sectional view through a motor vehicle component of at least one embodiment of the disclosure.

The figures use comparisons or reference numerals, even when there is no repeated description for reasons of simplification.

### DETAILED DESCRIPTION

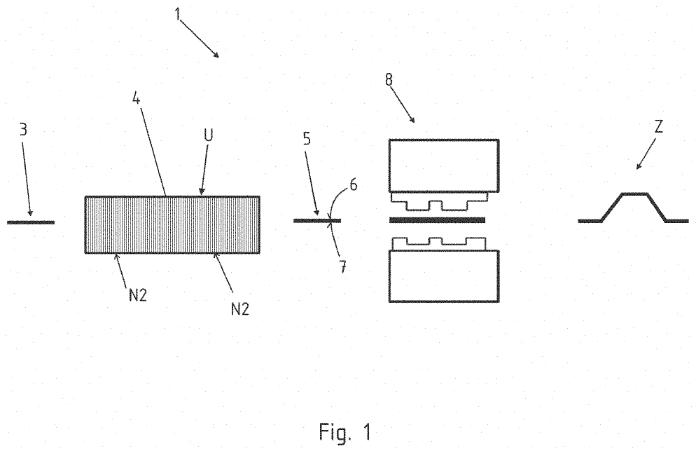

FIG. 1 shows a hot-forming line of at least one embodiment of the disclosure for production of a motor vehicle component produced by hot forming and press hardening.

First of all, a blank 3 is introduced into a continuous furnace 4. The continuous furnace 4, for adjustment of the furnace atmosphere within the continuous furnace 4, is supplied with ambient air U. The continuous furnace 4 is also supplied with nitrogen N of technical grade purity. The amount of nitrogen N of technical grade purity supplied is adjusted especially as a function of the percentage proportion by volume of oxygen measured within the furnace atmosphere. For this purpose, for example, measurement sites that measure the percentage proportion by volume of oxygen may be present within the continuous furnace 3. It is then possible to form an average from the measurement sites. The blank 5 thus heated has an already skin-decarburized layer at each surface 6, 7. The heated blank 5 is then transferred into a hot forming and press hardening mold 8, where it is hot-formed and press-hardened. The motor vehicle component 2 produced is removed from the hot forming and press hardening mold 8 and sent to further processing.

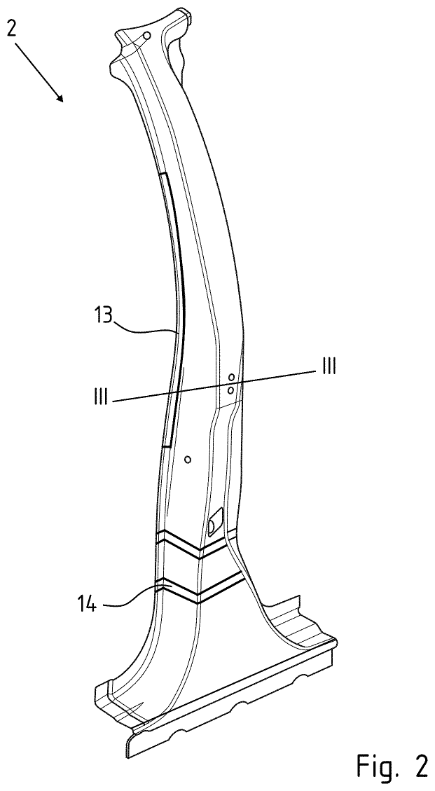

FIG. 2 shows a motor vehicle component 2 in perspective view. This may, for example, be a motor vehicle pillar, especially motor vehicle B pillar. However, it is possible to produce further motor vehicle components 2, especially structural motor vehicle components, by the method according to at least one embodiment of the disclosure. These further motor vehicle components 2 are, for example, longitudinal beams, transverse beams, struts, roof beams, sills or similar components of a motor vehicle chassis. There are also shown soft zones at the motor vehicle component, soft zones in a surrounding flange which might be in an at least partial surrounding flange 13 which might be a flange for coupling for joining with another not shown part. Also the flange can be trimmed in a cutting operation. Also there are other areas 14 which might be positioned in a lower part where also soft zones are preferably especially when the motor vehicle component is a B-pillar.

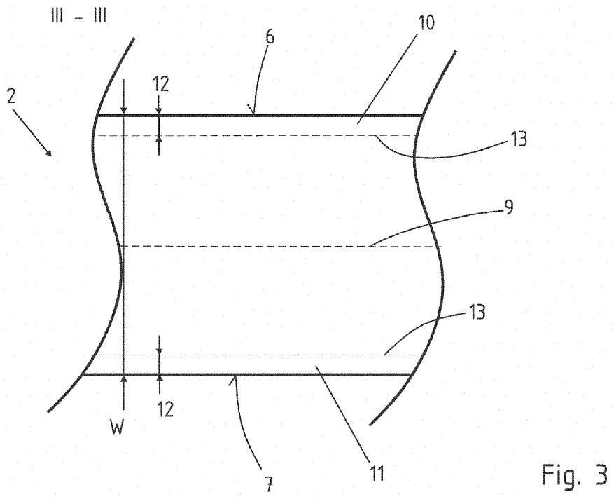

FIG. 3 shows a partial cross-sectional view according to the section line III-III from FIG. 2 through the motor vehicle component 2 produced. The entire cross section has for the B-pillar head shaped cross section. The motor vehicle component 2 has a wall thickness W. From each surface 6, 7 of the motor vehicle component 2, a skin-decarburized layer 10, 11 extends to a middle stratum or middle layer 9 or else referred to as core layer or core stratum. The skin-decarburized layer 10, 11 has a layer thickness 12. The layer thickness 12 is more preferably 20-40 μm. It is a feature of a layer boundary 13 of skin-decarburized layer 10, 11 to non-skin-decarburized layer that the carbon content in the skin-decarburized layer has 50% of the carbon content of the middle layer 9. Thus, if the carbon content, proceeding from the surface 6, 7 of the motor vehicle component produced, exceeds 50%, it can no longer be referred to as a skin-decarburized layer in the context of the disclosure.

It is a further advantage of at least one embodiment of the disclosure that the hot-formed and press-hardened motor vehicle component or the blank is subject to scaling to a negligible degree during heating.

The foregoing description of some embodiments of the disclosure has been presented for purposes of illustration and description. It is not intended to be exhaustive or to limit the disclosure to the precise form disclosed, and modifications and variations are possible in light of the above teachings. The specifically described embodiments explain the principles and practical applications to enable one ordinarily skilled in the art to utilize various embodiments and with various modifications as are suited to the particular use contemplated. It should be understood that various changes, substitutions and alterations can be made hereto without departing from the spirit and scope of the disclosure.

1. A method of producing a motor vehicle component having a tensile strength Rm greater than 1700 MPa, the method comprising:
heating a blank of a hardenable carbon-containing steel alloy having a carbon content of not less than 0.3 percent by mass in a continuous furnace to a temperature not less than an AC3 temperature of the steel alloy, while supplying nitrogen to the continuous furnace under closed-loop control to establish an oxygen content of 0.5% to 15% by volume in a furnace atmosphere in the continuous furnace;
removing the blank from the continuous furnace; and
hot forming and press hardening the blank, in a hot forming and press hardening mold, into the motor vehicle component having a bending angle greater than 50°.

2. The method as claimed in claim 1, wherein, in the supplying nitrogen to the continuous furnace, the oxygen content is controlled to be between 0.5% and 10% by volume.

3. The method as claimed in claim 1, wherein, in the supplying nitrogen to the continuous furnace, a nitrogen volume flow rate has a value per hour between two and four times a furnace volume of the continuous furnace.

4. The method as claimed in claim 1, wherein, in the supplying nitrogen to the continuous furnace, the nitrogen, based on a spatial direction, is introduced into the continuous furnace above the blank being heated.

5. The method as claimed in claim 1, wherein the blank is a tailored blank.

6. The method as claimed in claim 1, wherein, in the heating of the blank, the blank is guided through the continuous furnace within a period of 2 to 10 min.

7. The method as claimed in claim 1, wherein, in the heating of the blank, a temperature is between 910 and 980° C. in the continuous furnace.

8. The method as claimed in claim 1, wherein the steel alloy includes iron, melting-related impurities, and alloy elements, the alloy elements including
0.3-0.4% by mass of C (carbon),
0.15-1% by mass of Si (silicon),
0.5-2% by mass of Mn (manganese),
max 0.05% by mass of P (phosphorus),
max 0.01% by mass of S (sulfur),
max 0.01% by mass of N (nitrogen),
0.05-1% by mass of Cr (chromium),
max 0.3% by mass of Ni (nickel),
max 0.1% by mass of Cu (copper),
max 0.5% by mass of Mo (molybdenum),
max 0.1% by mass of Al (aluminum),
0.02-0.1% by mass of Nb (niobium),
max 0.06% by mass of V (vanadium),
max 0.1% by mass of Ti (titanium), and
0.001-0.01% by mass of B (boron).

9. A motor vehicle component, comprising:
a hot-formed press-hardened steel alloy having a carbon content not less than 0.3% by mass, wherein
the motor vehicle component has
a tensile strength Rm greater than 1700 MPa,
at a surface of the motor vehicle component, a skin-decarburized layer having a layer thickness of 10 to 70 μm, and
a bending angle greater than 50°.

10. The motor vehicle component as claimed in claim 9, further comprising:
a middle layer,
wherein the skin-decarburized layer has a carbon content at or less than 50% of the carbon content in the middle layer.

11. The method as claimed in claim 1, further comprising:
cathodic dip painting causing the motor vehicle component to have a yield strength Rp0,2 greater than 1300 MPa.

12. The method as claimed in claim 1, wherein, in the supplying nitrogen to the continuous furnace, the oxygen content is controlled to be between 0.5% and 5% by volume.

13. The method as claimed in claim 1, wherein, in the supplying nitrogen to the continuous furnace, the oxygen content is controlled to be between 0.5% and 3% by volume.

14. The method as claimed in claim 1, wherein, in the supplying nitrogen to the continuous furnace, a nitrogen volume flow rate has a value per hour between 2.5 and 3.5 times a furnace volume of the continuous furnace.

15. The method as claimed in claim 1, wherein, in the supplying nitrogen to the continuous furnace, a nitrogen volume flow rate has a value per hour three times a furnace volume of the continuous furnace.

16. The method as claimed in claim 1, further comprising, after the hot forming and press hardening, coating the motor vehicle component.

17. The method as claimed in claim 1, wherein, in the heating of the blank, the blank is guided through the continuous furnace within a period of 120 to 360 sec.

18. The method as claimed in claim 1, wherein, in the heating of the blank, the temperature within the continuous furnace is more than 5% higher than the AC3 temperature of the steel alloy.

19. The motor vehicle component as claimed in claim 9, wherein the motor vehicle component has
the tensile strength Rm greater than 1900 MPa,
the skin-decarburized layer having the layer thickness of 20 to 40 μm, and
the bending angle greater than 60°.

20. The motor vehicle component as claimed in claim 9, wherein the steel alloy includes iron, melting-related impurities, and alloy elements, the alloy elements including
0.3-0.4% by mass of C (carbon),
0.15-1% by mass of Si (silicon),
0.5-2% by mass of Mn (manganese),
max 0.05% by mass of P (phosphorus),
max 0.01% by mass of S (sulfur),
max 0.01% by mass of N (nitrogen),
0.05-1% by mass of Cr (chromium),
max 0.3% by mass of Ni (nickel),
max 0.1% by mass of Cu (copper),
max 0.5% by mass of Mo (molybdenum),
max 0.1% by mass of Al (aluminum),
0.02-0.1% by mass of Nb (niobium),
max 0.06% by mass of V (vanadium),
max 0.1% by mass of Ti (titanium), and
0.001-0.01% by mass of B (boron).
